(19) United States
(12) Patent Application Publication
(10) Pub. No.: US 2009/0207112 A1
(43) Pub. Date: Aug. 20, 2009

(54) VIEWING DEVICE AND BOOK-TYPE ARRANGEMENT OF A PLURALITY OF INTERCONNECTED VIEWING DEVICES

(76) Inventor: Oliver Heine, Oberraden (DE)

Correspondence Address: BROOKS KUSHMAN P.C., 1000 TOWN CENTER, TWENTY-SECOND FLOOR, SOUTHFIELD, MI, 48075, US

(21) Appl. No.: 12/095,213

(22) PCT Filed: Nov. 18, 2006
(86) PCT No.: PCT/DE2006/002025

§ 371 Date: Oct. 27, 2008

(30) Foreign Application Priority Data
Nov. 28, 2005 (DE) 10 2005 056 873.4

(51) Int. Cl. G09G 3/36; A47G 1/08; A47G 1/06

(52) U.S. Cl. 345/87; 40/781; 40/714

(57) ABSTRACT

The invention relates to a viewing device having viewing openings for viewing a flat object present on an object support in the interior of the housing. The invention provides a viewing device which is as flat as possible in its rest position and which can be changed to a viewing position in a simple and reproducible manner and with little effort. The housing is erected using a lever-type cover element which at least partially covers the front in the rest position of the viewing device and which can be swiveled outward in order to erect the housing.

The invention relates to a viewing device with a housing having a front wall and a rear wall, wherein at least the front wall has at least one viewing opening for viewing a flat object which is located inside the housing on an object carrier. The invention furthermore relates to a book-type arrangement of a plurality of interconnected viewing devices.

A viewing device of this type is known from WO 2005/051141 A1. In this known viewing device, the inner surface, which cambers away from the viewer, of the rear wall of the housing is used as the object carrier in order to produce a spatial impression of the respective object, in particular of an image. It is furthermore provided in the known viewing device to design the outer surface of the front wall of the housing such that it cambers toward the viewer.

It has proven disadvantageous that the known viewing device typically comprises a rigid three-dimensional housing and that therefore its interim storage or its transport requires a relatively large amount of space.

WO 2005/051141 A1 also proposes a viewing device which has, in its rest position, the form of a flat card-type sleeve and can therefore be stored and transported in a space-saving manner. In order to bring the viewing device into its viewing position when it is correctly used, the viewer must squeeze together the device at the connecting lines between front and rear wall using a hand so that a housing with cambered front and rear walls results, inside which housing, for example on the rear wall, the image to be viewed is located.

Irrespective of the fact that this process of squeezing together the device at the two connecting lines initially requires an explanation for an unaware viewer, maintaining the viewing position needs a continuous action of force on the two connecting lines. Typically, no reproducible representations of the image to be viewed are furthermore formed because the pressure on the connecting line from the front and rear walls, and thus the camber of the image carrier, which camber is decisive for the spatial impression of the image, is different for different viewers. Finally, the front wall of the known housing likewise exhibits a relatively strong outward camber in the viewing position, which is often undesired.

The present invention is based on the object of specifying a viewing device which has, in its rest position, as flat a design as possible and which can be readily adjusted into a reproducible viewing position with little force being exerted, wherein the front wall preferably has, in the viewing position, a plane surface or a surface which is only slightly cambered. Furthermore, the aim is to disclose a book-type arrangement of a plurality of interconnected viewing devices.

Said object is achieved according to the invention with respect to the viewing device by way of the features of claim 1 and with respect to the book-type arrangement by way of the features of claim 19. Further, particularly advantageous embodiments of the invention are disclosed in the subclaims.

The invention is largely based on the concept that a collapsible housing, comprising at least one side wall in the erect viewing position, is used as the housing of the viewing device, wherein the housing is erected by way of a cover element which is designed in a lever-type fashion, at least partially covers the front wall in the rest position of the viewing device and can be pivoted outwardly in order to erect the housing.

The housing has for this purpose an additional folding line in the front wall in the vicinity of either of the two connecting lines between the front and rear walls such that the region between said connecting line and the folding line forms a side wall when the housing is erected. The cover element is preferably connected in a force-fitting manner on the outside to that region of the front wall which forms the side wall in the viewing position, with the result that, as the cover element is pivoted into an opened position, this region of the front wall pivots with it and is thus erected with respect to the remaining front wall.

Unlike in the case of operating known viewing devices in which the connecting lines between the front and rear walls must be squeezed together in order to erect the housing, no additional explanation for erecting the housing is needed in the viewing device according to the invention, since relevant processes of opening cover elements (e.g. in the case of books, opening the relevant book cover or in the case of greeting cards the opening of the front face etc.) are known to users of these devices and are thus automatically completed correctly.

Using the cover element achieves reproducible erection of the housing of the viewing device, wherein typically the viewing device is held using one hand and the cover element is held using the other hand when the housing is erected. The force the viewer needs to exert is relatively low since the cover element is considerably wider than that region of the front wall which forms the side wall (lever action).

The object to be viewed can be arranged directly on the inside of the rear wall (the rear wall itself is in this case the object carrier) or on an additional object carrier which is arranged between the front and rear walls, is preferably connected in a force-fitting manner to at least one side of the viewing housing and the length of which is chosen such that it is supported on the opposite side of the housing of the viewing device.

If the object carrier is intended to have a cambered shape in order to give the viewer a spatial impression of the respective object, the object carrier must have a greater width when the viewing position is achieved than the width of the front wall, which faces the viewer in said position.

If the rear wall has no folding lines corresponding to the front wall in the region of the second connecting line, the width of the front wall, which faces the viewer, is shortened with respect to the width of the rear wall by the side wall when the housing is erected, and the rear wall cambers outwards in a defined manner. Therefore, if the rear wall of the viewing device forms the object carrier at the same time, a spatial impression of the relevant object which is arranged on the object carrier is produced, which impression changes as the pivot path of the cover element is changed. Here, the front face of the housing remains substantially flat.

In another embodiment of the viewing device according to the invention, the rear wall is also provided with a folding line in the region of the second connecting line of the front and rear walls, with the result that a cuboid housing is formed when the device is opened from the rest position into the viewing position by means of the cover element, which housing has a substantially rectangular cross section when the side walls have the same width.

In a third embodiment of the invention, the cover element is provided with a folding line in the region of the front end of the region of the front wall, which region forms the corresponding side wall, with the result that the cover element can be readily completely folded over up to behind the rear wall and can be connected in this position to the rear wall by way of a fastening apparatus (e.g. a hook-and-loop faster) such that it can be released on the outside.

If desired, in addition to the front wall, the rear wall can also be provided with a viewing opening for viewing an object located in the housing. In this case, the separate object carrier arranged inside the housing serves both for retaining an object on its side facing the front wall of the housing and for retaining an object on its side facing the rear wall.

Suitable materials used for the housing and the cover element can be both paperboard (cardboard) and plastic, but also a correspondingly suitable metal. Material combinations of rigid and flexible, non-transparent and transparent materials, which can for example be adhesively bonded together, are also possible.

The cover element, in particular, can be made of a transparent material (e.g. a transparent PVC film) such that the object (image or the article) arranged in the housing is visible to a viewer also in the rest position of the front and rear walls. However, it may also be provided that, in addition to the cover element, the front and rear walls are also made of a transparent material.

It can furthermore be provided that the object carrier can be illuminated by means of at least one light source which can be arranged inside the housing. Here, the object carrier can be made of a transparent material and can be illuminated from the rear face of the housing.

In particular for advertising purposes, the viewing device can be designed such that it comprises an additional space for retaining another flat article (e.g. a CD and/or a book etc.).

It can also be provided that a pivotable cover element is provided also in the region of the second connecting line from front and rear walls in order to increase the stability when the viewing device is set up. The symmetrical arrangement of the two cover elements can also result in the viewing device having an effect for the viewer which is visually more pleasing than if only one cover element is used.

Other details and advantages of the invention emerge from the exemplary embodiments explained below with reference to figures, in which:

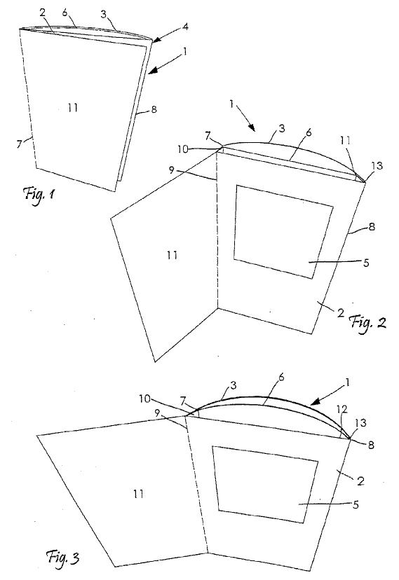

FIG. 1 shows a perspective view of a first exemplary embodiment of a viewing device according to the invention, in which the housing is in its rest position;

FIG. 2 shows a perspective view of the viewing device illustrated in FIG. 1, in which the housing is in a first viewing position;

FIG. 3 shows a perspective view of the viewing device illustrated in FIG. 1, in which the housing is in a second viewing position;

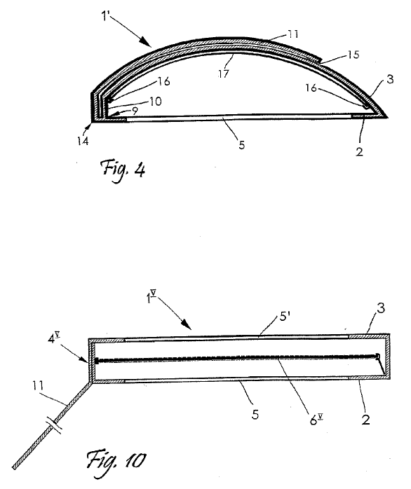

FIG. 4 shows a cross section through a diagrammatically illustrated viewing device which corresponds to FIG. 2, wherein a cover element which can be folded over up to the rear face of the rear wall and can be fastened there is provided;

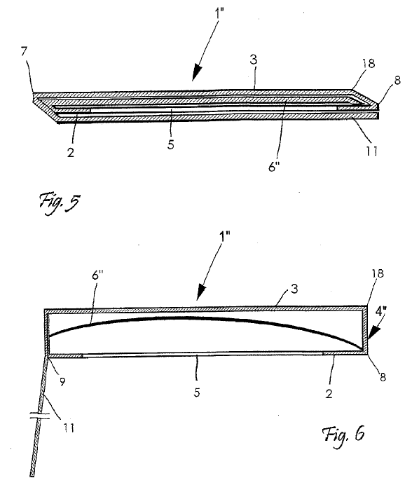

FIGS. 5 and 6 show plan views of a diagrammatically illustrated second exemplary embodiment of a viewing device according to the invention, wherein the housing is in its rest position (FIG. 5) and in a viewing position (FIG. 6);

FIG. 7 shows a plan view of a viewing device corresponding to FIG. 6, in which, in addition to the object to be viewed, a flat article, such as a CD or DVD, is accommodated in the housing;

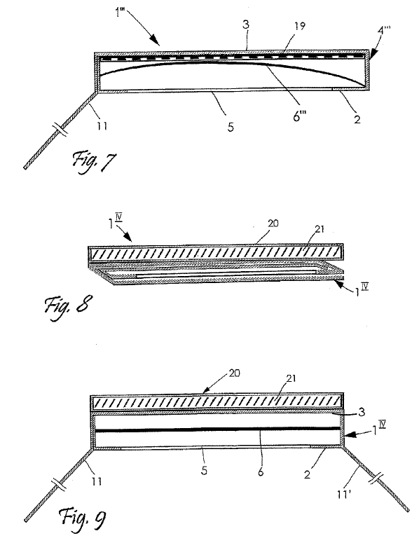

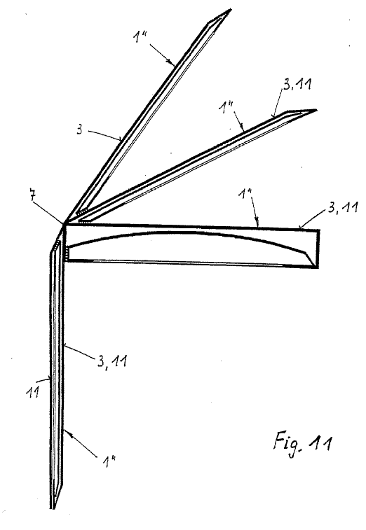

FIGS. 8 and 9 show plan views of another exemplary embodiment of the viewing device according to the invention, wherein the viewing device is connected to a goods retaining container for a book and has two cover elements which are arranged in a mutually symmetrical fashion;

FIG. 10 shows a plan view of a diagrammatically illustrated exemplary embodiment of a viewing device according to the invention, in which both the front and the rear wall are in each case provided with a viewing opening;

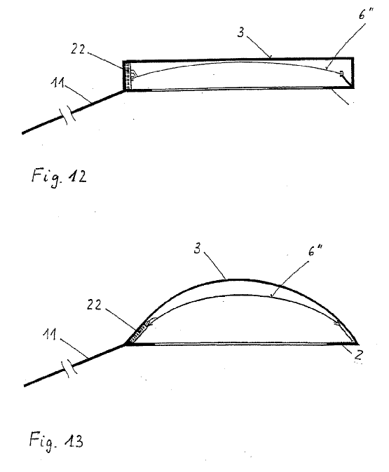

FIG. 11 shows a book-type arrangement comprising a plurality of viewing devices; and

FIGS. 12 and 13 show viewing devices with object carriers, which are organic displays.

In FIGS. 1-3, 1 denotes a viewing device according to the invention, which substantially comprises a housing 4 having a front wall 2 and a rear wall 3, wherein the front wall 2 has a viewing opening 5 for viewing an image (not illustrated) which is located inside the housing 4 on a separate object carrier 6.

The front and rear walls 2 and 3, which are in each case made of a flexible material, are connected along two opposing lateral edge regions, which together form in each case one connecting line 7, 8, such that they are arranged to be spaced apart from one another after the transition from a rest position of the housing 4, in which they lie flat one against the other, into an opened first and/or second viewing position of the housing 4.

The front wall 2 of the viewing device 1 has, in the vicinity of the first connecting line 7, a folding line 9 which extends parallel to the connecting line 7, so that the region 10, which is located between the first connecting line 7 and the first folding line 9, of the front wall 2 forms a first side wall after a first viewing position (FIG. 2) is achieved when the housing 4 is erected.

The housing 4 is erected here according to the invention with the aid of a cover element 11, which at least partially covers the front wall 2 in the rest position of the viewing device 1 and which is connected in a force-fitting manner (or in one piece) on the outside with that region of the front wall 2 which forms the side wall 10, and which cover element 11, by pivoting into an opened position, takes along that region of the front wall 2 which forms the side wall 10.

A reproducible erection of the housing 4 is achieved due to the use of the cover element 11, wherein the viewing device 1 is typically held with one hand and the cover element 11 with the other hand when the housing 4 is erected.

Since in the exemplary embodiment illustrated in FIGS. 1-3 the width of the front wall 2 facing the viewer during the erection process of the housing 4 is shortened with respect to the width of the rear wall 3 by the side wall 10 that forms, the result is a rear wall 3 which is outwardly cambered.

The image carrier 6 is connected in a force-fitting manner (e.g. by means of an adhesive bond), in the wall region, which forms the side wall 10, of the viewing device 1, to said wall region, wherein the width of the image carrier 6 is selected such that it is somewhat less than the width of the rear wall 3 and has, on its side which faces the second connecting line 8, a folding line 12. This achieves that, during opening of the cover element 11 into the first viewing position (FIG. 2), an image carrier 6 is formed without a cambered profile or with a profile which is only slightly cambered, wherein the image carrier 6 is supported by its second end 13 on the inside at the second connecting line 8.

If the cover element 11 is subsequently pivoted further into a second viewing position (FIG. 3), the image carrier 6 is likewise pushed into an outwardly cambered position so that the corresponding image which is arranged on the image carrier 6 has such a camber and gives the viewer a spatial impression.

FIG. 4 illustrates a viewing device 1′, in which the cover element 11 is not rigidly fastened to the region, which forms the side wall 10, of the front wall 2, but is provided with a folding line 14 in the region of the front end of the region, which forms the corresponding side wall, of the front wall. Thus, the cover element 11 can be readily folded over behind the rear wall 3 and can be fastened in this position by way of a fastening apparatus (e.g. a hook-and-loop fastener) 15 on the outside on the rear wall 3 such that a free-standing viewing device is produced. Here, the housing is, however, basically not erected until the cover element 11 has reached an angle of 180°, since prior to that the region, which characterizes the side wall 10, of the front wall 2 is not taken along to any significant degree on account of the folding line 14.

In this viewing device 1′, the rear wall 3, which is provided on its inside with holders 16 for an image 17 to be displayed, serves as the image carrier.

As can be seen from FIG. 4, the entire viewing device 1′ can be produced simply by folding of a corresponding blank, e.g. made of cardboard, a plastic film or a sheet metal.

In the viewing device 1″ according to the invention, which is illustrated in FIGS. 5 and 6, the rear wall 3 is also provided with a second folding line 18 in the region of the second connecting line 8 of front and rear walls 2 and 3, with the result that, in the viewing position (FIG. 6), a cuboid housing 4″ with a substantially rectangular cross section is produced.

Here, either the rear wall 3 can once again be used as the image carrier, in which case, however, no cambered image-carrier surface is produced, or, as illustrated in FIGS. 5 and 6, a separate image carrier 6″, having a width which is greater than the width of the front or rear walls 2 and 3 in the viewing position (FIG. 6), is used such that, as the cover element 11 is pivoted into its opened position (FIG. 6), the image carrier (and thus also the image to be viewed) cambers toward the rear wall 3.

FIG. 7 shows a plan view of a viewing device 1′″ corresponding to FIG. 6, in which, in addition to the image to be displayed on an image carrier 6′″, a flat article 19 (e.g. a CD) is accommodated in the housing 4′″ between the image carrier 6′″ and the rear wall 3.

FIGS. 8 and 9 show plan views of a viewing device 1^{IV}, wherein the viewing device is connected to a goods retaining container 20 (e.g. for a book 21) and has two cover elements 11 and 11′ which are arranged in a mutually symmetrical fashion. Here, only the left cover element, which is denoted by 11 in FIG. 9, is used for opening the viewing device 1^{IV}. The right cover element 11′, on the other hand, is merely intended to enhance the stability when standing of the entire arrangement.

Finally, FIG. 10 shows a plan view of a schematically illustrated viewing device 1^{V} according to the invention, in which both the front and the rear walls 2, 3 are in each case provided with a viewing opening 5, 5′. In this case, the separate object carrier or image carrier 6^{V} which is arranged inside the housing 4^{V} is used to arrange an image or another article both on its side facing the front wall 2 and on its side facing the rear wall 3. Such a viewing device can be used, for example, for a restaurant menu.

The invention is, of course, not limited to the exemplary embodiments described above. For example, the viewing device according to the invention can also be used to display flat objects, such as coins, stamps, banknotes and vouchers, which appear, for example, in front of a flat or cambered image backdrop which is arranged on the rear wall.

It can also be provided that, rather than just one object carrier, two object carriers are arranged axially one behind the other inside the housing of the viewing device, wherein a viewer can see through the first image, which is arranged on the first object carrier, to the underlying second image, which is arranged on the second object carrier.

Furthermore, the front wall does not necessarily have to be made of a flexible material, but, as it is typically not intended to deform, a rigid material can also be used.

Similar statements are also true for the cover element. The cover element should likewise preferably be made of a flexible material only if the cover element is intended to be fastened outside to the rear wall of the housing of the viewing device and if the rear wall is of cambered design.

It can also be provided that a plurality of viewing devices according to the invention for three-dimensional objects are interconnected on one side in a hinge-like manner—like the pages of a book. It is thus possible to view the individual objects successively, wherein those viewing devices whose objects are not intended to be viewed are in their rest position and only the viewing device whose object is viewed is in its viewing position.

A corresponding exemplary embodiment is illustrated in FIG. 11. Here, the individual viewing devices which are in each case interconnected in a hinge-like manner at their first connecting line 7 largely correspond to the viewing device 1″ illustrated in FIGS. 5 and 6. With the exception of the last (top) viewing device 1″, the respective rear wall 3 of the respective viewing device 1″ at the same time serves as a cover element 11 of the next viewing device 1″.

The respective object carrier of the viewing device according to the invention can also be LCDs, organic displays (OLEDs), electronic paper etc. It has proven advantageous in such cases to arrange the electronics for actuating the displays likewise in the viewing device. Two corresponding exemplary embodiments of such viewing devices are shown in FIGS. 12 and 13.

The exemplary embodiment illustrated in FIG. 12 is a viewing device corresponding to FIGS. 5 and 6 with cuboid housing, where an organic display is used as the object carrier 6″. The corresponding chip with the electronics 22 for actuating the display is located at the left side edge of the housing 4″.

FIG. 13 shows a viewing device which largely corresponds to FIG. 12, where merely the rear wall 3 of the housing 4 (corresponding to FIGS. 1-3) is of cambered design.

### LIST OF REFERENCES

1-1^{V} viewing devices
2 front wall
3 rear wall
4,4″,4′″,4^{V} housing
5,5′ viewing opening
6,6″,6′″,6^{V} object carrier, image carrier
7 (first) connecting line
8 (second) connecting line
9 (first) folding line
10 region, side wall
11,11′ cover elements
12 folding line
13 end
14 folding line
15 fastening apparatus
16 holder
17 object, image
18 (second) folding line
19 article
20 goods retaining container
21 book
22 electronics

1. A viewing device with a housing having a front wall and a rear wall, wherein at least the front wall has at least one viewing opening for viewing a flat object which is located inside the housing on an object carrier, and wherein the front and rear walls are interconnected along two opposing connecting lines such that they are arranged to be spaced apart from one another after the transition from a rest position, in which they lie flat one against the other, into a viewing position, characterized by the features:
a) the viewing device has, in the vicinity of the first connecting line between the front and rear walls, a first folding line in the front wall, so that the housing forms a side wall after a viewing position between the first connecting line and the first folding line is achieved; and
b) a cover element is fastened to the wall region, which forms the side wall, of the front wall, which cover element can be pivoted from a closed position, in which it at least partially covers the front wall on the outside, into an opened position, in which the side wall is erect.

2. The viewing device as claimed in claim 1, characterized in that the rear wall of the viewing device forms the object carrier.

3. The viewing device as claimed in claim 1, characterized in that at least one separate object carrier is arranged between the front and rear walls and is connected in a force-fitting manner at the wall region, which forms the side wall, of the viewing device to said wall region.

4. The viewing device as claimed in claim 3, characterized in that the width of the object carrier corresponds to the width of the rear wall.

5. The viewing device as claimed in claim 3, characterized in that the width of the object carrier is less than the width of the rear wall and in that the object carrier has, on its side which faces the second connecting line, a folding line, so that the object carrier is supported by its end on the inside at the second connecting line and by its folding line on the rear wall when the cover element is opened.

6. The viewing device as claimed in claim 3, characterized in that, in addition to the front wall, the rear wall also has at least one viewing opening and in that the object carrier serves for arranging an object both on its side facing the front wall and on its side facing the rear wall.

7. The viewing device as claimed in claim 3, characterized in that the object carrier is a display comprising LCD elements, an organic display or a display comprising electronic paper.

8. The viewing device as claimed in claim 7, characterized in that the electronics required for actuating the displays is arranged at least partially in the housing of the viewing device.

9. The viewing device as claimed in claim 1, characterized in that the viewing device (1″-1^{V}) has, in the vicinity of the second connecting line between the front and rear walls, a second folding line in the rear wall, so that the cover element forms a cuboid housing when it is opened.

10. The viewing device as claimed in claim 1, characterized in that the cover element is provided with a folding line in the region of the front end of the side wall such that the cover element can be fastened in its completely opened position by way of a fastening apparatus on the outside to the rear wall.

11. The viewing device as claimed in claim 10, characterized in that a hook-and-loop fastener is provided as the fastening apparatus.

12. The viewing device as claimed in claim 1, characterized in that the cover element is made of a transparent material such that the image arranged in the housing or the article is visible to a viewer even in the rest position of the front and rear walls.

13. The viewing device as claimed in claim 1, characterized in that the object carrier can be illuminated by way of at least one light source which can be arranged inside the housing.

14. The viewing device as claimed in claim 13, characterized in that the object carrier is made of a transparent material and can be illuminated from the rear wall of the housing.

15-18. (canceled)

19. A book-type arrangement of a plurality of interconnected viewing devices as claimed in claim 1, characterized in that the individual viewing devices are interconnected in a hinge-like manner at their first connecting lines such that the respective rear wall of a viewing device forms the cover element of the respectively next viewing device.
